(19) United States
(12) Patent Application Publication
(10) Pub. No.: US 2011/0092617 A1
(43) Pub. Date: Apr. 21, 2011

(54) METHOD FOR BURNING COAL INVOLVING IMPLEMENTING AN ABSORBENT AGENT IN AN AQUEOUS DISPERSION, ASHES OBTAINED, AND USES THEREOF

(75) Inventor: Yves Kensicher, Theize (FR)

(73) Assignee: COATEX S.A.S., Genay (FR)

(21) Appl. No.: 12/992,205

(22) PCT Filed: May 6, 2009
(86) PCT No.: PCT/IB2009/005546

§ 371 Date: Nov. 11, 2010

(30) Foreign Application Priority Data
May 21, 2008 (FR) 08 02737

(51) Int. Cl. C04B 7/28; C04B 24/26

(52) U.S. Cl. 524/2; 524/69

(57) ABSTRACT

The invention consists of a process for manufacturing ashes from the combustion of coal, this process comprising at least one step of bringing the coal into contact with an absorbent agent on the one hand, this absorbent agent being, on the other hand, contained in an aqueous phase in the presence of a (meth)acrylic dispersant, preferably a (meth)acrylic comb polymer. Thus the emissions of carbon dioxide and likewise the compounds based on sulphur, nitrogen or mercury which result from the combustion of coal are effectively combated.

The use of coal in power plants is very significant; these plants provide 40% of worldwide electricity production. Long considered old-fashioned, coal is becoming attractive again, as energy needs are such that the maximum production capacities of oil or natural gas will soon be reached: this contributes to exhausting the natural reserves of these products and causes a spike in prices, which directly affects the end consumer.

There is, however, a first challenge, upon which the sustainability of coal as a preferred natural resource for providing our planet with energy depends: reducing greenhouse gas emissions, particularly as imposed by the Kyoto Protocol. However, although a current coal power plant emits much less CO₂ per kilowatt-hour of product burned than an older one (owing to its superior output), it emits twice as much as a gas power plant. In order to prevent technologies derived from burning coal from harmfully contributing to climate change, it is therefore essential to limit the release of CO2.

Furthermore, when coal is burned in order to produce power, it is also sought to recycle the products resulting from this process: they are solid residue, derived from this burning, also known as ash. For years, this ash has been implemented in the manufacture of cement, particularly Type I cement, also known as Portland cement, which constitutes a basic material for the worldwide construction industry. On this matter, one may refer to the documents “Concrete of high C3A slag cement using coal ash as raw material” (Semento Gijutsu Nenpo, 1983, (37), pp. 514-17), “Use of coal-mining wastes as a minor component in raw material for cement clinker production” (Cement-Wapno-Gips, 1983, (12), pp. 326-8), and “Manufacture of a new type of blended cement using limestone and coal ash as main raw materials” (Semento Gijutsu Nenpo, 1988, (42), pp. 48-51).

This recycling of ash derived from burning coal gives rise to a second challenge: it has turned out that obtaining this ash, via temperatures which are sometimes greater than 1,000° C., causes the emission of compounds which are both toxic and hazardous to the environment, particularly sulfur-based, nitrogen-based, or mercury-based compounds. These compounds, although they do not contribute to global climate change, remain undesirable nonetheless: besides being poisonous to human beings, they may also harm plant and animal species, and more generally, our ecosystems.

In order to fight emissions of greenhouse gases like carbon dioxide, while at the same time limiting the presence of sulfur-, nitrogen-, and mercury-based compounds, the person skilled in the art initially conceived of developing method-oriented solutions. To that effect, absorber-neutralizer devices may be cited, which are intended to absorb and then neutralize toxic fumes (see the document EP 1 059 112) and the technology called SCR or Selective Catalytic Reduction (see the document EP 1 687 567). However, these methods remain expensive, and require that they be adapted to the restrictions of each industrial site.

The person skilled in the art has also turned towards introducing various additives, which act as absorbents for the indesirable compounds derived from coal burning. It is thus known how to implement cement, slaked or unslaked lime, and calcium oxide (see the documents EP 0 292 083, JP 9 173 768 and CN 1 962 034), halogen compounds particularly including calcium bromide (see the document WO 07 149867), or alumino-silicates (see the document U.S. Pat. No. 4,116,705). As emphasized in the documents WO 2006 099 611 and WO 2007 092 504, these additives are implemented in the form of powders, previously mixed with coal or added directly into the combustion chamber.

Continuing her research into effectively fighting emissions of carbon dioxide and sulfur-, nitrogen-, and mercury-based compounds during industrial coal burning, the applicant has developed a method for manufacturing ash from coal burning, by bringing the coal into contact before being burned and/or while it is burning, and/or by bringing the fumes resulting from burning the coal into contact, with at least one absorbent compound, characterized in that said absorbent compound is in the form of an aqueous dispersion containing a dispersing agent.

Contrary to the state of the art, which disclosed the implementation of such compounds in powder form, entirely unexpected effects were observed related to the implementation of these additives in an aqueous phase and in the presence of a dispersing agent: emissions of harmful compounds are advantageously reduced, particularly carbon dioxide. Preferentially, when the dispersing agent is a (meth)acrylic comb polymer, CO₂ emissions are reduced even more significantly. Nothing in the prior art described nor suggested such a result.

Without wishing to be bound by any theory, the Applicant believes that the effective surface available to absorb the harmful compounds is increased by the presence of a dispersing agent in the aqueous phase: the particles of the absorbing agent, dispersed in a stable and uniform fashion, exhibit a larger effective surface for the absorption mechanisms, than in a powder in which the individual particles are subject to agglomeration and/or clumping phenomena.

In the present Application, the term “absorbing agent” here refers to any compound that may, through physical-chemical surface mechanisms, absorb all or some of the compounds emitted during the burning of carbon, particularly including carbon dioxide and sulfur-, nitrogen-, and mercury-based compounds. These compounds are described not necessarily exhaustively, but to a broad extent, within the aforementioned documents EP 0 292 083, JP 9 173 768, CN 1 962 034, WO 07 149867, U.S. Pat. No. 4,116,705, WO 2006 099 611 and WO 2007 092 504.

The term “aqueous dispersion” designates a medium in which water constitutes the continuous liquid phase, with solid particles being dispersed within it: in this situation, they are particles of the aforementioned absorbing agent.

The term “dispersing agent” designates a chemical additive whose function is to regulate the viscosity of a liquid medium containing at least one solid chemical, in view of dispersing the solid chemical (the absorbing agent) within the continuous phase (the water) in a manner that is stable over time.

The term “(meth)acrylic polymer” designates a polymer made up of at least one acrylic and/or methacrylic monomer.

The term “(meth)acrylic comb polymer” designates a polymer made up of an essentially linear and acrylic and/or methacrylic skeleton, upon which are grafted at least 2 side segments made up of at least one “macromonomer”. The term “macromonomer” designates a polymer or copolymer that is not water-soluble, and that has at least one terminal group with an unsaturated ethylenic function. In this sense, the expression “(meth)acrylic comb polymer” refers both to structures as described in the documents WO 2007/052122 and in the French patent application filed as number 07 00086, as well as in the documents U.S. Pat. No. 7,232,875, U.S. Pat. No. 6,815,513 and U.S. Pat. No. 6,214,958.

Thus, a first object of the invention consists of a method for manufacturing ashes from burning coal, comprising the steps of:

a) producing an aqueous dispersion of at least one absorbent compound with a dispersing agent,

b) burning the coal while:
b1) putting said dispersion in contact with the coal, doing so before it is burned and/or while it is being burned,
b2) and/or putting said dispersing agent in contact with the fumes resulting from burning the coal.

In concrete terms, we therefore begin by manufacturing an aqueous dispersion, by mixing the absorbent compound, the dispersing agent, and the water in the proportions defined by the person skilled in the art. Next, this dispersion is put directly into contact with the coal before it is burned (typically in storage areas, or during a potential step of coal granulation that may precede its burning) or while it is being burned (i.e. by being injected into the combustion chamber). It may also be put into contact, at the outlet of the combustion chamber, with the fumes resulting from said burning of coal.

This method is further characterized in that said dispersing agent is a (meth)acrylic polymer.

According to one preferential variant, this method is characterized in that said dispersing agent is a (meth)acrylic comb polymer.

This method is further characterized in that said (meth)acrylic comb polymer contains at least one monomer chosen from among acrylic acid, methacrylic acid, their esters, and mixtures thereof.

This method is further characterized in that said (meth)acrylic comb polymer contains at least one monomer whose formula is (I):

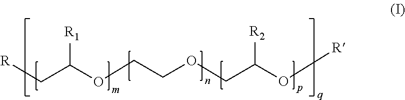

where:
m, n, p and q are whole numbers and m, n, p are less than 150, q is greater than 0, and at least one whole number among m, n and p is nonzero,
R has a polymerizable vinylic function, preferably a methacrylic one,
R1 and R2 are identical or different, and represent hydrogen atoms or alkyl groups,
R′ represents hydrogen or a hydrocarbonated radical having 1 to 40 carbon atoms, preferentially 1 to 12 carbon atoms, and very preferentially 1 to 4 carbon atoms, R′ extremely preferentially being the methyl radical.

This method is further characterized in that said (meth)acrylic comb polymer is made up of, expressed as a percentage by weight of each of its components:
1) 1% to 20%, preferentially 2% to 15%, very preferentially 3% to 12% of at least one monomer chosen from among acrylic acid, methacrylic acid, their esters, and mixtures thereof.
2) 80% to 99%, preferentially 85% to 98%, and very preferentially 88% to 97% of at least one monomer whose formula is (I).

This method is further characterized in that said (meth)acrylic polymer and said (meth)acrylic comb polymer are fully or partially neutralized by at least one neutralization agent, chosen from among hydroxides and/or oxides of calcium, magnesium, barium, lithium, from among hydroxides of sodium, potassium, or ammonium, from among primary, secondary, and tertiary amines, and mixtures thereof.

This method is further characterized in that the absorbing agent is chosen from among cement, hydroxides and/or oxides of calcium, magnesium, sodium, potassium, or lithium and mixtures thereof, halogens, and preferentially calcium bromide, alumino-silicates, and mixtures thereof.

This method is further characterized in that said aqueous dispersion contains 0.01% to 0.3% by dry weight of absorbing agent compared to its total weight.

This method is further characterized in that the dry weight of the dispersing agent is between 0.02% and 0.5% the weight of the absorbing agent.

This method is further characterized in that the molecular weight of the dispersing agent, as determined by Gas Phase Chromatography, is between 10,000 g/mol and 80,000 g/mol, and preferentially between 15,000 g/mol and 40,000 g/mol.

Another object of the invention resides in the ashes obtained by burning coal, through the implementation of the inventive method.

A final object of the invention is the use of these ashes, in the manufacturing of hydraulic binder-based compositions, preferentially cement compositions, and very preferentially Portland cement compositions.

### EXAMPLES

In all of the examples, as in the entirety of the present application, the molecular weight of the polymers used is determined by the method described below, using Size Exclusion Chromatography (SEC).

A test tube of the polymer solution corresponding to 90 mg of dry matter is added into a 10 mL flask.

The mobile phase is added, plus 0.04% THF, up to a total mass of 10 g.

The composition of this mobile phase is as follows: NaNO₃: 0.2 mol/L, CH3COOH: 0.5 mol/L, acetonitrile 5% by volume.

The SEC chain consists of a Waters™ 510 isocratic pump, the flow of which is set to 0.8 mL/min, a Waters 717+ autosampler, an oven containing a “Guard Column Ultrahydrogel Waters™” precolumn, followed by an “Ultrahydrogel Waters™” set of columns with a 7.8 mm internal diameter and 30 cm in length, for which the nominal porosities are, in order of connection: 2,000, 1,000, 500, and 250 Å.

Detection is ensured by a Waters™ 410 type differential refractometer.

The temperature of the oven and the detector is set at 35° C.

The chromatogram is acquired and processed using the software PSS WinGPC Scientific v 4.02.

The SEC is calibrated by a series of sodium polyacrylate standards provided by Polymer Standard Service with the references PAA 18 K, PAA 8K, PAA 5K, PAA 4K, PAA 3K.

The calibration curve is linear and takes into account the correction obtained using the flow marker (THF).

### Example 1

This example illustrates the capacity of a mineral mixture, subject to a gas mixture containing carbon dioxide, to absorb the CO₂. Several tests are carried out, including one control, in which the mineral is in powdered form and is free of all additives, a test according to the prior art in which the mineral gets added an absorbing agent in the form of a particulate solid, and two tests according to the invention in which the mineral is placed in an aqueous dispersion in the presence of two acrylic dispersing agents, one of which is of the comb type.

### Test #1—Reference: Preparation of a Powdered Mineral Mixture for Reducing Carbon Dioxide in a Gas Effluent.

The mineral mixture is prepared by homogenizing, in a powder mixer, 747 g of slaked lime (Ca(OH)₂) and 253 g of limestone marl, the two minerals having previously been ground and filtered before achieving a maximum particle size of 250 micrometers.

The homogeneous mixture is then placed in a cylindrical chamber whose bottom is made up of a fritted glass whose porosity is between 16 and 40 micrometers. The base of the chamber is connected to a source of a gaseous mixture of air enriched with carbon dioxide, which has a 5% CO₂ content by volume. The flow of the gas mixture is set to 1 liter per minute, and the composition of the gas exiting the chamber is analyzed by means of gas chromatography coupled with a mass spectrometer, using methods well known to the person skilled in the art, every 5 minutes after a 10-minute ramp-up period (in the following tests, the carbon dioxide contents are determined using this method).

The carbon dioxide content of the exiting gas mixture stabilizes around 2.5% by volume during the 40 minutes of the test. 50% of the carbon dioxide is therefore absorbed by the mineral mixture.

Test #2—Prior Art: Preparation of a Mineral Mixture in an Aqueous Suspension without a Dispersing Agent for Reducing Carbon Dioxide in a Gas Effluent.

A mineral mixture identical to that implemented for test #1 is prepared and then placed in a suspension in water in a proportion of 1,000 g of mixture for 2,333 g of water, the Brookfield™ viscosity of the mixture being 350 mPa·s (at 10 revolutions/minute and at 25° C.). A greater dry solids content is not possible, as the viscosity increases very quickly with the solids content.

The dispersion prepared in this way is added into a solid-bottomed cylindrical chamber, equipped with a fritted glass bubbler whose porosity is between 16 and 40 micrometers. The bubbler is connected to a source of a gaseous mixture of air enriched with carbon dioxide and having a 5% CO₂ content by volume. The flow of the gas mixture is set to 1 liter per minute, and the composition of the gas exiting the chamber analyzed every 5 minutes after a 10-minute ramp-up period.

The carbon dioxide content of the gas mixture exiting stabilizes at around 0.5% by volume and then slowly increases for the duration of the test, finishing at 0.7% by volume after 40 minutes.

90% of the carbon dioxide is therefore absorbed by the mineral mixture at the start of the test, with the ratio reaching 86% at the end of 40 minutes.

### Example 3—Invention

### Preparation of a Mineral Mixture in an Aqueous Suspension with a Sodium Polyacrylate Dispersing Agent for Reducing Carbon Dioxide in a Gas Effluent

A mineral mixture identical to the one implemented in test #1 is prepared and then suspended in water in a proportion of 1,000 g of mixture for 666 g of water and 5.8 g of an aqueous solution of sodium polyacrylate having 43% solids content and an average molecular mass of 3,500 g/mol, the Brookfield™ viscosity of the mixture being 400 mPa·s (at 10 revolutions/minute and at 25° C.). The dispersion prepared in this way is added into a solid-bottomed cylindrical chamber, equipped with a fritted glass bubbler whose porosity is between 16 and 40 micrometers. The bubbler is connected to a source of a gaseous mixture of air enriched with carbon dioxide and having a 5% CO₂ content by volume. The flow of the gas mixture is set to 1 liter per minute, and the composition of the gas exiting the chamber analyzed every 5 minutes after a 10-minute ramp-up period.

The carbon dioxide content of the gas mixture exiting stabilizes at around 0.4% by volume and then slowly increases for the duration of the test, finishing at 0.52% by volume after 40 minutes.

92% of the carbon dioxide is therefore absorbed by the mineral mixture at the start of the test, the ratio reaching 89.6% at the end of 40 minutes.

### Example 4—Invention

### Preparation of a Mineral Mixture in an Aqueous Suspension with a Comb Polymer Dispersing Agent for Reducing Carbon Dioxide in a Gas Effluent

A mineral mixture identical to example 1 is prepared and then suspended in water in a proportion of 1,000 g of mixture 666 g of water and 2.25 g of an aqueous solution of comb polymer of 40% solids content and an average molecular mass of 25,800 g/mol, the Brookfield™ viscosity of the mixture being 330 mPa·s (at 10 revolutions/minute and at 25° C.).

Said comb polymer is made up of:
10% by weight of methacrylic acid,
90% by weight of methoxypolyethylene glycol methacrylate, with a molecular weight equal to 2,000 g/mole,

It is fully neutralized by sodium hydroxide, and its molecular weight is 28,000 g/mol. It is obtained by a conventional polymerization method, as is well known to a person skilled in the art.

The dispersion prepared in this way is added into a solid-bottomed cylindrical chamber, equipped with a fritted glass bubbler whose porosity is between 16 and 40 micrometers. The bubbler is connected to a source of a gaseous mixture of air enriched with carbon dioxide and having a 5% CO₂ content by volume. The flow of the gas mixture is set to 1 liter per minute, and the composition of the gas exiting the chamber analyzed every 5 minutes after a 10-minute ramp-up period.

The carbon dioxide content of the exiting gas mixture stabilizes in the vicinity of 0.36% by volume and then slowly increases for the duration of the test, finishing at 0.41% by volume after 40 minutes.

92.8% of the carbon dioxide is therefore absorbed by the mineral mixture at the start of the test, with the ratio reaching 91.8% at the end of 40 minutes.

These results demonstrate that the quantity of carbon dioxide absorbed is greater when the mineral mixture is dispersed in water in the presence of an acrylic dispersing agent (tests #3 and 4): the absorption capacity of such a mineral mixture will therefore be increased when it is implemented in the inventive coal burning method.

It is also demonstrated that, according to the preferential variant of the invention, the best results are obtained when a comb acrylic polymer is used (test #4).

1: A method for manufacturing ashes from burning coal, the method comprising:
a) manufacturing an aqueous dispersion of at least one absorbent compound with a dispersing agent that is a (meth)acrylic polymer,
b) burning the coal while:
b 1) contacting said aqueous dispersion with the coal, doing so before the coal is burned and/or while the coal is being burned,
b2) and/or contacting said dispersing agent with fumes resulting from burning the coal.

2: The method according to claim 1, wherein said dispersing agent is a (meth)acrylic comb polymer.

3: The method according to claim 2, wherein said (meth)acrylic comb polymer comprises at least one monomer selected from the group consisting of acrylic acid, methacrylic acid, an ester of acrylic acid, and an ester of methacrylic acid.

4: The method according to claim 2, wherein said (meth)acrylic comb polymer comprises at least one monomer whose formula (I) is: 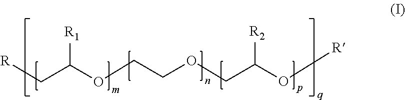
wherein:
m, n, p and q are whole numbers and m, n, p are less than 150, q is greater than 0, and at least one whole number among m, n and p is nonzero,
R has a polymerizable vinylic function,
R₁ and R2 are identical or different, and represent hydrogen atoms or alkyl groups,
R′ represents hydrogen or a hydrocarbon radical having 1 to 40 carbon atoms.

5: The method according to claim 2, wherein said (meth)acrylic comb polymer comprises expressed as a percentage by weight of each of its components:
1) 1% to 20% of at least one monomer selected from the group consisting of acrylic acid, methacrylic acid, an ester of acrylic acid, and an ester of methacrylic acid;
2) 80% to 99% of at least one monomer whose formula is (I) 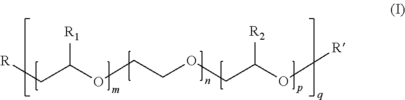
wherein:
m, n, p and q are whole numbers and m, n, p are less than 150, q is greater than 0, and at least one whole number among m, n and p is nonzero,
R has a polymerizable vinylic function,
R₁ and R2 are identical or different, and represent hydrogen atoms or alkyl groups,
R′ represents hydrogen or a hydrocarbon radical having 1 to 40 carbon atoms.

6: The method according to claim 1, wherein said (meth)acrylic polymer is fully or partially neutralized by at least one neutralization agent selected from the group consisting of hydroxide, calcium oxide, magnesium, barium, lithium, magnesium oxide, barium hydroxide, barium oxide, sodium hydroxide, potassium hydroxide, ammonium, primary amine, a secondary amine, and a tertiary amine.

7: The method according to claim 1, wherein the absorbing agent is at least one selected from the group consisting of cement, calcium hydroxide, calcium oxide, magnesium, hydroxide, magnesium oxide, sodium, sodium hydroxide, sodium oxide, potassium hydroxide, potassium oxide, lithium hydroxide, lithium oxide potassium, or lithium, a halogen, calcium bromide, and an alumino-silicate.

8: The method according to claim 1, wherein said aqueous dispersion comprises 0.01% to 0.3% by dry weight of the at least one absorbent compound compared to a total weight of said aqueous dispersion.

9: The method according to claim 1, wherein a dry weight of the dispersing agent is between 0.02% and 0.5% the weight of the absorbent compound.

10: The method according to claim 1, wherein a molecular weight of the dispersing agent, as determined by Gas Phase Chromatography, is between 10,000 g/mol and 80,000 g/mol.

11: Ashes obtained by the method according to claim 1.

12: A process for manufacturing a hydraulic binder-comprising composition, the process comprising adding the ashes according to claim 11 to a hydraulic binder-comprising composition precursor.

13: The method according to claim 4, wherein R has a polymerizable methacrylic vinylic function.

14: The method according to claim 4, wherein R′ represents a hydrocarbon radical having 1 to 12 carbon atoms.

15: The method according to claim 4, wherein R′ represents a hydrocarbon radical having 1 to 4 carbon atoms.

16: The method according to claim 4, wherein R′ represents a methyl radical.

17: The method according to claim 5, wherein said (meth)acrylic comb polymer comprises:
1) 2% to 15% of at least one monomer selected from the group consisting of acrylic acid, methacrylic acid, an ester of acrylic acid, and an ester of methacrylic acid.

18: The method according to claim 5, wherein said (meth)acrylic comb polymer comprises:
1) 3% to 12% of at least one monomer selected from the group consisting of acrylic acid, methacrylic acid, an ester of acrylic acid, and an ester of methacrylic acid.

19: The method according to claim 5, wherein said (meth)acrylic comb polymer comprises:
2) 85% to 98% of the at least one monomer whose formula is (I).

20: The method according to claim 5, wherein said (meth)acrylic comb polymer comprises:
2) 88% to 97% of the at least one monomer whose formula is (I).
